(19) United States
(12) Patent Application Publication
(10) Pub. No.: US 2014/0257902 A1
(43) Pub. Date: Sep. 11, 2014

(54) SYSTEMS AND METHODS FOR INCORPORATING CALENDAR FUNCTIONALITY INTO ELECTRONIC MESSAGES

(71) Applicant: Baydin, Inc., Mountain View, CA (US)

(72) Inventors: Alexander MOORE, Mountain View, CA (US); Michael Chin, Mountain View, CA (US); Aye Moah, Mountain View, CA (US)

(73) Assignee: Baydin, Inc., Mountain View, CA (US)

(21) Appl. No.: 14/198,791

(22) Filed: Mar. 6, 2014

Related U.S. Application Data
(60) Provisional application No. 61/775,429, filed on Mar. 8, 2013.

(51) Int. Cl. G06Q 10/10; G06F 17/28

(52) U.S. Cl. CPC G06Q 10/1093; G06F 17/28
USPC 705/7.18

(57) ABSTRACT

A system is provided which determines that an electronic message contains natural language that relates to calendar functionality. Calendar functionality may broadly be considered any function relating to a typical Calendar application or any function typically applied to a calendar entry in an electronic calendar system or calendar application. The system may determine an association between said natural language and structured data, and modify a representation of said natural language to reflect the association between said natural language and structured data. The structured data may be structured data from a user's electronic calendar system.

### RELATED APPLICATION

This application claims the benefit of Provisional U.S. Patent Application No. 61/775,429 filed Mar. 8, 2013.

### BACKGROUND

Users of information technology increasingly use electronic calendar systems and applications to manage their appointments, meetings, events, and other scheduled activities through various forms of calendar entries. Users access these systems through computers, mobile phones, tablets, and other electronic devices.

Electronic communications have almost completely supplanted telephonic, written, and in-person methods of coordinating meetings. This increase means that users spend increasing amounts of time converting between electronic communication systems, such as those that facilitate correspondence via electronic message (such as e-mail or social networking platforms) and electronic calendar systems.

Increasingly, services are being offered that perform rudimentary integration between electronic communication systems and electronic calendar systems, especially in a business context. Examples of these systems include Microsoft Outlook and Exchange, Google Calendar and Gmail, Zimbra Calendar and Mail, and Zoho Calendar and Mail.

One conventional method for performing this integration includes providing a link or button to access the electronic calendar system from the electronic communication system, and vice versa. Another method provides the ability to “drag and drop” an email message into the calendar system, which allows the user to specify that the message contains event details, fill in those details manually, then include the body of the message in the calendar appointment.

Conventional methods are fraught with human transcription errors, as they require the user to change contexts between the electronic communication system and the electronic calendaring system to complete scheduling tasks.

Conventional methods are optimized for creating and maintaining a schedule for a single person, whereas most calendar scheduling involves multiple participants and multiple options. For example, a user may receive an email from a coworker asking for a meeting, with a list of times included. In a conventional workflow, the user must 1) Switch to the electronic calendar application, 2) verify each of the times to see which are suitable, 3) switch back to the email application to send a response, 4) wait for his coworker to confirm one of the times, 5) switch back to the calendar application to finally add an appointment to his schedule, 6) remind his coworker of the meeting beforehand. This process can lead to lost productivity, unnecessary stress, transcription mistakes, double-booking appointment times, and missed meetings.

Electronic mail specifications do not provide for the ability for electronic messages to be modified after they are sent, which prevents electronic communication systems from offering dynamic messages that can change based on a user's interactions or other data sources.

### SUMMARY

Applicants have appreciated that available electronic communications technology does not provide effective tools for coordinating meetings, appointments, and scheduling. Existing electronic communications products are largely separated from electronic calendar products, with only limited connection points between them. Using electronic communications technology to coordinate scheduling information with others is left to the user.

Applicants have further appreciated that existing electronic calendar technology does not provide effective means for coordinating multiparty appointments. Traditional electronic calendars provide the means for multiple people to be participants in a meeting, and the ability to send meeting requests via electronic communications. They do not, however, provide a means for choosing from a set of times for an appointment, a means for effectively translating incoming meeting requests, methods for reminding other attendees about a meeting, or a means to track pending appointments that have not been confirmed. Additionally, they do not provide effective tools for choosing meeting locations.

Modifying Natural Language Segments Related to Calendar Functionality in an Electronic Message

A system is provided in which instructions are executed which perform a method for identifying specific data in unstructured natural language text, linking that data with structured data sources, modifying or annotating that text with additional information from structured data sources, and adding interactive components that facilitate completing tasks that depend on the specific data.

In some embodiments of the present disclosure, the system may be applied to electronic messages that contain information related to calendar functionality. Calendar functionality may broadly be considered any function relating to a typical Calendar application or any function typically applied to a calendar entry in an electronic calendar system or calendar application. Such calendar functions may include, but are not limited to: creating a calendar entry (such as an appointment, reminder, event, telephone conference, meeting, or any other entry of information in an electronic calendaring system or application), deleting a calendar entry, modifying a calendar entry, inviting others to a calendar entry, removing others from a calendar entry, scheduling a calendar entry, determining whether conflicts exist amongst calendar entries of a plurality of individuals, etc.

In some embodiments of the present disclosure, the system may be applied to electronic messages that contain natural language relating to appointments, scheduling, or meetings, such as locations, dates, or participant lists.

In some embodiments, structured data in a structured data source may be comprised of electronic scheduling data stored in one or more hosted or non-hosted electronic calendaring systems (such as Microsoft Exchange, Google Calendar, Zimbra Calendar, etc.). In some embodiments, these systems may be used as sources of data for determining whether a segment of natural language in an electronic message is related to calendar functionality. In some embodiments, additional information from additional sources of structured data may be used to determine whether a segment of natural language in an electronic message is related to calendar functionality. These structured data sources may also be used as sources of information that are relied upon for modifying or annotating a segment of natural language that is related to calendar functionality. Structured data may be comprised of a calendar entry, or may be comprised of an empty timeslot in a user's calendar that reflects that a time slot is open.

In some embodiments, structured data in a structured data source may be user-specific data. In some embodiments, structured data in a structure data source may be data specific to at least one sender or recipient of the electronic message. For example, in some embodiments, the structured data may reflect information from a calendar entry in an electronic calendar system or application. In some embodiments, the structured data may reflect information about an open time slot for which nothing is scheduled in an electronic calendar system.

In some embodiments, the system may automatically add structure to natural language text that contains information related to appointments, scheduling, or meetings and compare that information to information in the structured data source to determine whether or not a user is free or busy at a date or time provided in the unstructured text.

In some embodiments, the system may automatically, without user input, add visual elements, including but not limited to colors and formatting of the language relating to the structured data, as a method for annotating the unstructured text.

In some embodiments, these annotations may convey the recipient's availability at a specified date and time. In some embodiments, modifications such as changes to color (green for available, red for unavailable, yellow or orange for tentatively available or partially unavailable) may be applied to a segment of natural language in an electronic message so as to convey the recipient's availability at a specific time and date.

In some embodiments, the system may automatically, without user input, add visual elements, including but not limited to, symbols like “+” to the unstructured text, in order to provide interactive elements that use information from the structured data source to facilitate completion of tasks that depend on this data by users.

In some embodiments, the system may add visual elements that invoke a method for automatically structuring the natural language text that relates to the data source into a format matching the data source, and adding that data to the source.

In some embodiments, this method may provide for adding events to a user's calendar through interaction with symbols inserted into the natural language text.

In some embodiments, the system may automatically, without user input, add interactive behavior to elements in the unstructured text that provide additional, related information about the text relating to the structured data source, sourced from the structured data source

In some embodiments, those interactive behaviors may include a “hover” behavior that provides a formatted view of the user's schedule for the same day as the detected date and time information.

In some embodiments, elements added through a user's interaction with the natural language text may themselves contain interactive elements that provide additional ways to interact with the structured data source.

In some embodiments, these elements may provide ways to see the data detailed in unstructured text as they would appear in the structured data source.

In some embodiments, these elements may invoke a method for automatically structuring the natural language text that relates to the data source into a format matching the data source, and adding that data to the source.

Tentative Scheduling of Calendar Entries

A system and method for allowing users to create calendar entries with special properties is provided. These properties provide a method by which a user may propose a set of calendar entries, store information identifying these entries as a set, and then automatically remove these entries once other attendees of the entry have confirmed a single time.

The set of calendar entries may consist of one calendar entry, or a plurality of calendar entries.

The user may annotate this set of calendar entries at the time he enters them into his electronic calendar system or application or after they have already been created.

The user may add these appointments through the appointment creation interface of their primary electronic calendar system or application or through any system that integrates with their primary electronic calendar system or application.

Annotated properties may include but are not limited to information about the set of calendar entries: time, date, location, notes, title, attendees, unique identifiers; information about the method by which the user entered the appointments into his electronic calendar system; specific contextual information from any calendar-integrated application, such as unique identifiers of messages if the user created the appointments through a calendar-integrated electronic messaging application.

These annotated properties may be stored as part of the same data source as the event details, such as in a hosted calendar system (Google Calendar, Zimbra Calendar) or a locally-served calendar system (Microsoft Exchange), or in a separate data source.

The system may use any combination of annotated properties, data from other applications, and user-inputted data directly entered into the system to identify that a newly-added event relates to a set of annotated events.

In some embodiments of the invention, the system may use data about the electronic messages exchanged as part of the event-creation process to relate a newly-added event to a set of annotated events.

In some embodiments of the invention, the system may use overlap between the start and end times of a newly-added event and the start and end times of an event in an annotated set to create an association between them.

In some embodiments of the invention, when the system detects that a newly-added event relates to a set of annotated events, the system may prompt the user to remove the set of annotated events from his calendar.

In some embodiments of the invention, each of the annotated events may include, as part of the event details, uniquely identifiable information that allows a program to remove these events from a user's calendar individually or as a set.

Appointments that have been annotated with these properties may include a special delineation in the title of the appointment, which may comprise beginning with a set of symbols, or another method, to indicate their status both visually and programmatically.

Organizing Group Calendar Entries via Electronic Messages

A system and method are provided for collecting data directly from an electronic message and dynamically adapting the content of the electronic message based on the input of data to the message from its recipients. In some embodiments, the system may be directed to organizing the preferences and availability of a plurality of prospective attendees associated with a calendar entry.

The system provides for a user (“the organizer”) who wishes to collect data from a set of one or more people (“recipients”) and provide real-time information to those recipients via an electronic message.

The system sends an electronic message to each of the recipients which includes both a form that provides the ability to input data directly from the electronic message and an embedded image loaded from a server on the internet.

The image may be assembled by the server when a recipient's electronic messaging client requests it, or it may be pre-assembled. In some embodiments, the image may be displayed in an electronic message via a reference embedded in the electronic message. In some embodiments, the image may be displayed by being directly embedded in the electronic message. In some embodiments, an image directly embedded in an electronic message may be updated when a user opens or re-opens the message.

The image may be created, entirely or in part, based on data collected from the recipient requesting the image, and data collected from other recipients.

The image may be re-created each time a recipient's electronic message client requests it.

The image may be the same or different for each of the recipients.

The image may provide information about the status of each recipient's entry of data into the included form.

The image may provide information based on the processing of any combination of data collected from recipients, including via the form provided in the electronic message, and external data sources, including the electronic calendar systems or applications of the recipients.

The system may send an electronic message to the organizer that allows the organizer to view the results via an image and interact with the results via interface elements added to the electronic message.

The image provided to the organizer may be the same as the image provided to the recipients, or it may be different. In some embodiments, only the organizer may see an image that reflects responses for all recipients. In some embodiments all recipients may only see an image that reflects responses from organizer and a particular recipient.

In one embodiment of the invention, the organizer may request answers to a series of multiple-choice questions in the included form, and display the results of those questions in a grid format.

In a further embodiment of the invention, the system may include symbols and colors in the grid to emphasize the results.

In one embodiment of the invention, the organizer may conduct a poll or survey via an electronic message and share the votes of each of the recipients amongst all the recipients via the image. In some embodiments, such a poll or survey may comprise multiple choice questions.

In another embodiment of the invention, the organizer can send a list of possible times for an event to a set of recipients via electronic messaging. The organizer can request that they provide their availability at each of those times, and provide their responses to any subset of the recipients.

In a further embodiment of the invention, the message delivered to the organizer may include elements that provide for confirming an event time, including elements that allow the organizer to add the event to his own calendar and prefill an electronic message to any subset of the recipients with confirmation details.

In an embodiment of the invention, the system can automatically fill in requested data on behalf of the recipients, through annotation of the message with elements not visible to user and interaction with a structured data source.

Providing Suggestions for Time and Locations for Calendar Entries

A method is provided for determining suggested times and locations for meetings automatically.

The method may use a combination of user-specific data, publicly-accessible data, geolocation data, and user-inputted data in order to determine the optimal time and location of a meeting.

The method may present a suggested time and location for the meeting based on assumed user preferences. The system may then provide a method for a user to regenerate the time and location after specifying preferences. In some embodiments, the suggested time and location may be based, at least in part, on a user's prior selection of time and locations for prior calendar entries.

The method may provide the ability for the user to independently modify or regenerate times and locations.

The method may store data about a user's previous interaction with this system and may draw from that data to assume user preferences or annotate any other data source input.

In accordance with one embodiment of the invention, the method may aggregate data from venue databases (for example, popular websites and social media providers such as Yelp, Google Places, Foursquare), data from electronic calendar systems, and data from mapping systems (Such as Google Maps or Mapquest) and process this data according to a weighing system.

In accordance with a further embodiment of the invention, the system may automatically present an optimal weighing based on assumed user preferences.

In accordance with a further embodiment of the invention, the system may generalize user preferences into a set of common meeting vehicles, such as breakfast meetings, lunch meetings, dinner meetings, meetings for drinks, or meetings at coffeehouses.

Scheduling Across Multiple Time Zones

A method is provided for facilitating the proposal of meetings in more than one time zone via electronic messages.

The method may be invoked from either a user's electronic calendar system or his electronic messaging system.

The method may display a graphical view of the user's events from his electronic calendar system.

The user may specify acceptable meeting times by clicking-and-dragging, by clicking alone, or by using a keyboard to select times.

In accordance with one embodiment of the system, the user clicks a dropdown next to the time zone display in the graphical view of the calendar system. The user may either change the time zone or add an additional time zone to the message.

In accordance with a further embodiment of the invention, the user may select from a list of time zones that are geographically located near his own, or he may search for a specific time zone.

The system causes the list of selected dates and times to be inserted into an electronic message either within the user's electronic mail system, or via a system integrated with it. The system creates that list in a manner that lists each time in both time zones the user chose.

Automatic Reminders via Electronic Message of Calendar Entries

A method is provided for automatically sending calendar entry reminders via an electronic message.

When a user creates a calendar entry in an electronic calendar system, the system provides an option to attach a reminder email to the calendar entry.

The invention of the present disclosure may provide a default reminder time to the user. The default reminder time may be calculated based on the proximity of the event date to the current date.

The system automatically sends an email to the user and any other attendees associated with the calendar entry. In some embodiments, the recipients of the reminder message may be determined by relying, at least in part, on the recipients of previous electronic messages that mentioned the calendar entry.

If the user cancels the event, the system will automatically cancel the reminder.

The disclosure of the present invention may also be combined with systems and methods for applying game mechanics to the completion of tasks by users, as described in U.S. Patent Publication No. 2013/0006403 A1, the entirety of which is incorporated herein by reference.

### BRIEF DESCRIPTION OF THE FIGURES

The foregoing and other objects, aspects, features, and advantages of the disclosure will become more apparent and better understood by referring to the following description taken in conjunction with the accompanying drawings, in which:

FIG. 1A is a block diagram of a system for incorporating calendar functionality into electronic messages according to one embodiment of the present disclosure.

FIG. 1B is a block diagram of a system for providing a user interface to a user for incorporating calendar functionality into electronic messages according to one embodiment of the present disclosure.

FIG. 2 is a block diagram of an exemplary embodiment of a system 100 according to the present disclosure for executing computer executable instructions performed by processing arrangement 110 and/or a computing arrangement 110, according to one embodiment of the present disclosure.

FIG. 3 is an exemplary user interface demonstrating the incorporation of calendar functionality into an electronic message.

FIG. 4 is an exemplary user interface demonstrating the incorporation of calendar functionality into an electronic message.

FIG. 5 is an exemplary user interface demonstrating the incorporation of calendar functionality into an electronic message.

FIG. 6 is an exemplary user interface demonstrating the incorporation of calendar functionality into an electronic message.

FIG. 7 is an exemplary user interface demonstrating the incorporation of calendar functionality into an electronic message.

FIG. 8 is an exemplary user interface demonstrating the incorporation of calendar functionality into an electronic message.

FIG. 9 is an exemplary user interface demonstrating the incorporation of calendar functionality into an electronic message.

FIG. 10 is an exemplary user interface demonstrating the incorporation of calendar functionality into an electronic message.

FIG. 11 is an exemplary user interface demonstrating the incorporation of calendar functionality into an electronic message.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein and illustrated in the figures, can be arranged, substituted, combined, and designed in a wide variety of different configurations, all of which are explicitly contemplated and made part of this disclosure.

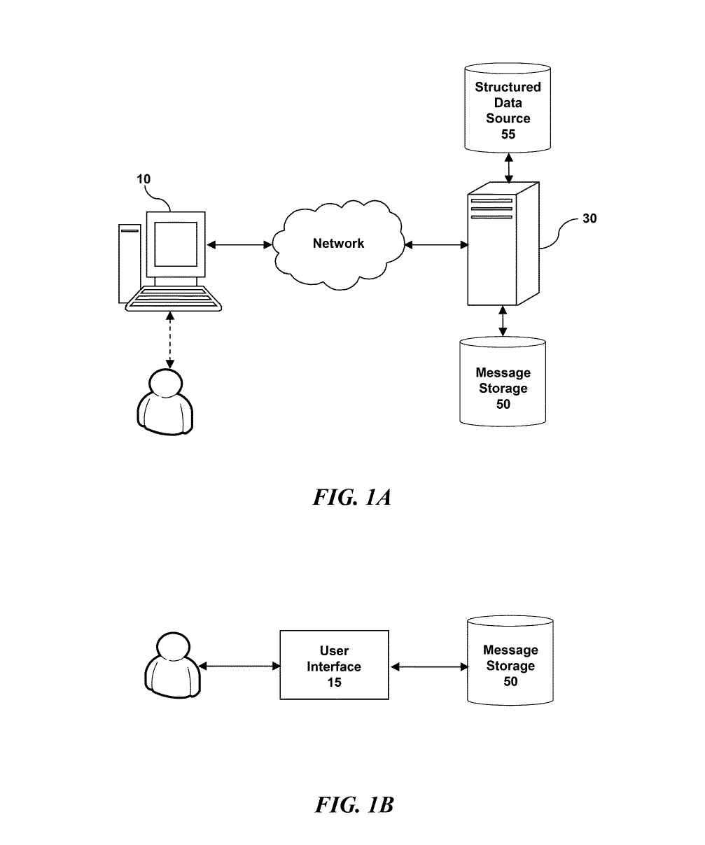

In reference now to FIG. 1A, a system for incorporating calendar functionality into electronic message is shown. Local machine 10 may access a server 30 which may provide electronic message services to a user. Local machine 10 may be a desktop computer, a server, a laptop, a tablet computer, a smart phone, or any other computing device capable of running a user interface. The server 30 may be a single server, a plurality of servers, a server farm, or computing services provided by a cloud based provider of computer services. Such a plurality of servers need not be located at the same location. In some embodiments, server 30 may be a plurality of servers operated by a plurality of different parties, entities, and service providers. The server 30 may be an electronic message server through which a user of local machine 10 may access electronic messages. Electronic messages may be stored in message storage 50. Structure data may be stored in structure data source 55. The Network depicted in FIG. 1A may be a local area network (LAN), wide area network (WAN), some other form of public or private network, or the Internet.

In some embodiments, message storage 50 may be located at local machine 10 rather than at a server. In some embodiments, message storage 50 may be distributed across local machine 10 and server 30. In some embodiments, message storage 50 may be replicated across a plurality of local machines 10 and servers 30.

In some embodiments, server 30 may be an E-mail server. In some embodiments, server 30 may be running Microsoft Exchange E-mail server software. In other embodiments, server 30 may be part of a hosted E-mail provider, such as the Gmail service presently provided by Google, Inc., the Hotmail service presently offered by Microsoft, or numerous other similar online services for providing users with access to electronic messages.

In some embodiments, structured data source 55 may be an electronic calendar system, including calendaring software systems, such as Microsoft Exchange, Google Calendar, Zimbra Calendar, iCal, etc.) In some embodiments, structured data source 55 may be a database of information associated with an electronic calendar system. In some embodiments, structured data source 55 may simply be a file or database representative of calendar information, such as an iCalendar file. In some embodiments, structured data source 55 may be any form of database that contains structured data related to calendar functionality. Structured data should be broadly understood as any form of structured data that could be stored in a database, file, or other mechanism for electronic storage. In some embodiments, structured data may reflect information from a calendar entry in a structured data source. In some embodiments, structured data may reflect information about an open time slot, or information reflecting that no calendar entry exists for a particular time period, from a structured data source.

In some embodiments, server 30 may be providing a user with a proprietary electronic messaging platform. For example, server 30 may be providing a user with the “Messages” feature offered by Facebook, Inc; the “InMail” feature provided by LinkedIn, or the “Direct Message” feature provided by Twitter. Numerous other proprietary messaging platforms are contemplated within the present disclosure.

In some embodiments, server 30 may be providing a user with access to voicemail services. In some embodiments, server 30 may be providing a user with electronically recorded audio voicemails. In some embodiments, server 30 may be providing a user with access transcribed voicemails. In some embodiments, server 30 may be providing a user with access to text messages, such as those utilizing the SMS protocol, or any other text message protocol.

The systems and methods of the present disclosure may be performed entirely at local machine 10, entirely at server 30, or on some combination of local machine 10 and server 30. In some embodiments, all the services that may be provided by server 30 may be provided by local machine 10, or a combination of local machine 10 and server 30. In some embodiments, all the service that may be provided by local machine 10 may be provided by server 30, or a combination of local machine 10 and server 30.

In some embodiments of the present disclosure, electronic messages stored at message 30 may be organized into different folders, labels, categorizations, collections, or any other manner of categorizing and organizing electronic messages. By default, most electronic messaging solutions provide that new messages are received and stored on behalf of the user at a particular folder, label, category, collection, or any other identifier for categorizing and organizing electronic messages. In the context of E-mail, most E-mail solutions provide that this default folder, label, category, collection, or any other identifier for categorizing and organizing electronic messages is identified as an “inbox.” Users of E-mail generally check their inbox for new messages and then reply, forward, delete, or archive their messages accordingly.

The concept of an inbox is generally applicable to all electronic messaging platforms beyond E-mail, and can be generalized as any folder, label, category, collection or any other identifier for categorizing and organizing electronic messages. For example, many users of E-mail utilize a “For Follow Up” folder to which they move E-mails to from the default “Inbox”. The user generally intends to follow up on these E-mails or perform some action on them at a later time. It would be understood by those skilled in the art that in such a situation, the “For Follow Up” folder may be a relevant inbox for the purposes of practicing the present disclosure, in addition to the default “Inbox” provided by the electronic messaging service. In some embodiments of the present disclosure, the default folder, label, category, collection, or other identifier for categorizing and organizing electronic messages in to which new messages are placed may not be labeled as an “Inbox”.

In reference now to FIG. 1B, a block diagram of an embodiment of a system for incorporating calendar functionality into an electronic message is depicted. A user interface 15 is provided to the user for performing the invention of the present disclosure. The user interface 15 is in communication with message storage 50. The user interface 15 and message storage 50 may be located on the same machine or on different machines. The user interface 15 may operate on local machine 10, server 30, or a combination of local machine 10 and server 30. The user interface 15 and message storage 50 may be in communication over a network. Electronic messages my be organized into folders, labels, categories, collections or by any other means for categorizing and organizing electronic messages at the user interface 15, at message storage 50, at server 30, or any one or combination of these. In some embodiments, user interface 15 may operate as a third-party intermediary between the user and his or her electronic message provider. In such embodiments, the user interface 15 may operate on a third party server 30, the electronic message service provider's servers 30, on local machine 10, or a combination of all of these.

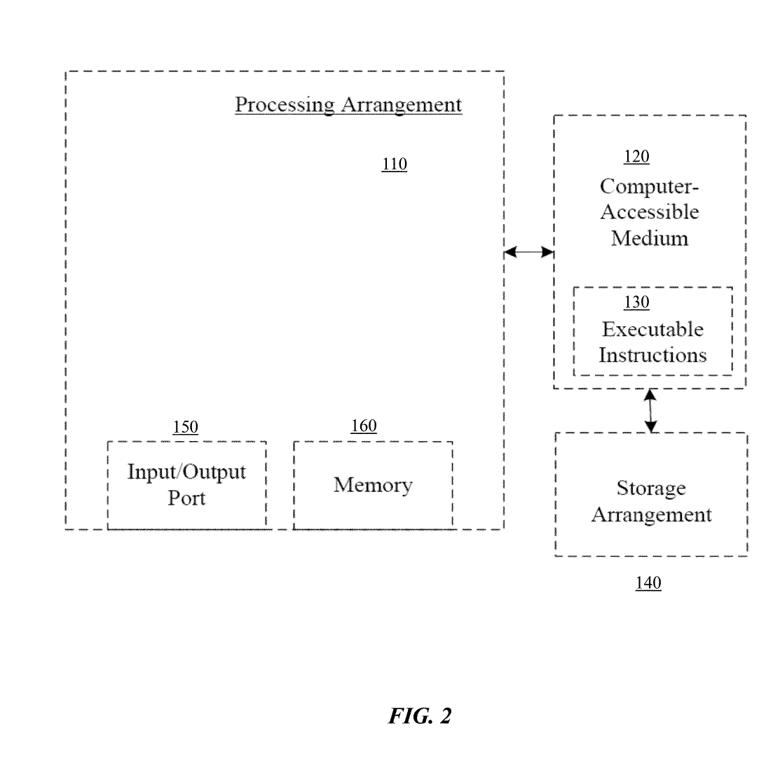

In reference now to FIG. 2, a block diagram of an exemplary embodiment of a system capable of implementing the present disclosure is shown. For example, an exemplary procedure in accordance with the present disclosure can be performed by a processing arrangement 110 and/or a computing arrangement 110. Such processing/computing arrangement 110 can be, e.g., entirely or a part of, or include, but not be limited to, a computer/processor that can include, e.g., one or more microprocessors, and use instructions stored on a computer-accessible medium (e.g., RAM, ROM, hard drive, or other storage device).

As shown in FIG. 2 a computer-accessible medium 120 (e.g., as described herein, a storage device such as a hard disk, floppy disk, memory stick, CD-ROM, RAM, ROM, etc., or a collection thereof) can be provided (e.g., in communication with the processing arrangement 110). The computer-accessible medium 120 may be a non-transitory computer-accessible medium. The computer-accessible medium 120 can contain executable instructions 130 thereon. In addition or alternatively, a storage arrangement 140 can be provided separately from the computer-accessible medium 120, which can provide the instructions to the processing arrangement 110 so as to configure the processing arrangement to execute certain exemplary procedures, processes and methods, as described herein, for example.

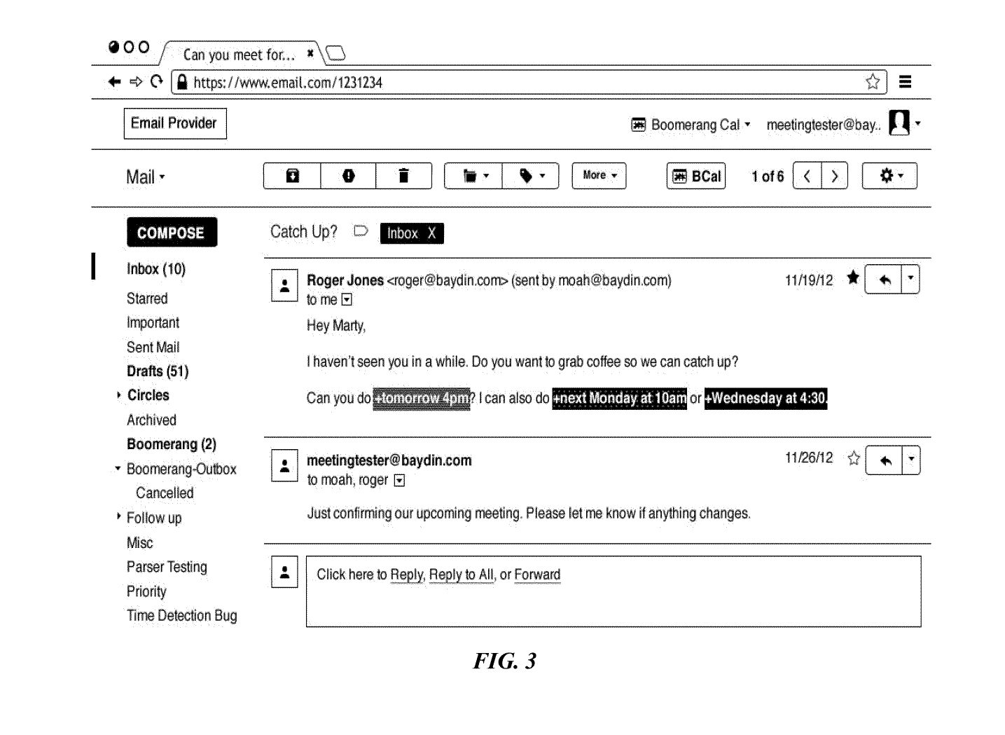

In reference now to FIG. 3, an embodiment of a method for incorporating calendar functionality into e-mail is depicted. In FIG. 3, the representation of the segments of natural language “tomorrow 4 pm”, “next Monday at 10 am” and “Wednesday at 4:30” have been modified according to the present disclosure. Pursuant to the present disclosure, a determination was made that these segments of natural language relate to calendar functionality. For example, these segments of natural language relate to schedule a calendar entry at the times designated (i.e. “tomorrow 4 pm”, “next Monday at 10 am”, and “Wednesday at 4:30”).

In further reference to FIG. 3, the representation of the natural language segments “tomorrow 4 pm”, “next Monday at 10 am” and “Wednesday at 4:30” have been modified so as to reflect an association between those segments of natural language and calendar functionality. In some embodiments, the modification may comprise underlining the segment of natural language. In some embodiments, the modification may comprise bolding or changing the font of the segment of natural language. In some embodiments, the modification may comprise making the segment of natural language a link. In some embodiments, the modification may comprise changing the color of the segment of natural language. In some embodiments, the modification may comprise annotating the segment of natural language in some fashion. In some embodiments, the modification may comprise adding characters or symbols before or after the segment of natural language. In some embodiments, the modification may comprise adding a symbol before or after the segment of natural language. In some embodiments, the modification may comprise adding an image before or after the segment of natural language. In some embodiments the modification may comprise substituting the segment of natural language with some form of structured text (for example, replacing “tomorrow at 4 PM” with “Tuesday, Nov. 20, 2012 4:00 PM”). In some embodiments, the modification may comprise at least one, a plurality, or all of these modifications.

In some embodiments, the modification to the segment of natural language may involve changing the color of the segment of natural language in a manner that relies at least in part on information from the electronic calendar system or application. For example, in some embodiments, a segment of natural language relating to a particular time for a possible calendar entry may be modified depending on whether a user is busy, available, or tentatively available for a particular time. For example, and with reference to FIG. 3, if a user is, according to information stored by the calendaring system or application in a structured data source, tentatively available at “tomorrow 4 PM”, not available “next Monday at 10 am”, and is available “Wednesday at 4:30”; “tomorrow 4 PM” may be modified by being colored yellow or orange to reflect that the user is tentatively available, “next Monday at 10 am” may be modified by being colored red to reflect that the user in not available, and “Wednesday at 4:30” could be colored green to reflect that the user is available.

In some embodiments, the modification to the representation of said segment of natural language may rely, at least in part, on structured data from a structured data source, such as an electronic calendar system. In some embodiments, the modification to the representation of said segment of natural language may rely, at least in part, on user-specific structured data, for example, a user's calendar information. In some embodiments, the modification to the representation of said segment of natural language may rely, at least in part, on a sender's electronic calendar system. In some embodiments, the modification to the representation of said segment of natural language may rely, at least in part, on at least one recipient's electronic calendar system. For example, structured data that reflects that a user already has a calendar entry for a given time period may result in the segment of natural language being colored red, whereas structure data reflecting that a user has something tentatively schedule for a given time period would lead to coloring the segment of natural language being colored yellow or orange, and structure data reflecting that a user has an open time slot, or nothing schedule during a particular time period, would result in the segment of natural language being colored green. In some embodiments, the modification of the representation of said segment of natural language may rely, at least in part, on whether a particular user is busy or available for the time period proposed according to structure data from an electronic calendar system that is specific to said user.

In some embodiments, the determining that an electronic message contains a segment of natural language that relates to calendar functionality may be made relying at least in part on the overall context of the electronic message, and may incorporate and analysis of the natural language of the entire message. For example, a determination that “tomorrow 4 pm” in FIG. 3 is a segment of natural language that relates to calendar functionality may rely, at least in part, on the fact that the electronic message contains the language indicative of a future meeting, such as the statement “Do you want to go grab coffee” in FIG. 3.

In some embodiments, the determining that an electronic message contains a segment of natural language that relates to calendar functionality may be made relying at least in part on prior electronic messages. For example, in FIG. 3 the determination that the natural language segment “tomorrow 4 pm” is related to calendar functionality may be made by relying at least in part on the content of prior electronic messages between Roger Jones and meetingtester@baydin.com. In some embodiments, the determination could be made by relying at least in part on prior e-mails between meetingtester@baydin.com and others. In some embodiments, the determination may be made by relying at least in part on structured data from a structured data source, such as an electronic calendar system. In some embodiments, the determination could be made by additionally relying at least in part on data from other sources, including publicly available data or databases of information for facilitating the parsing of natural language.

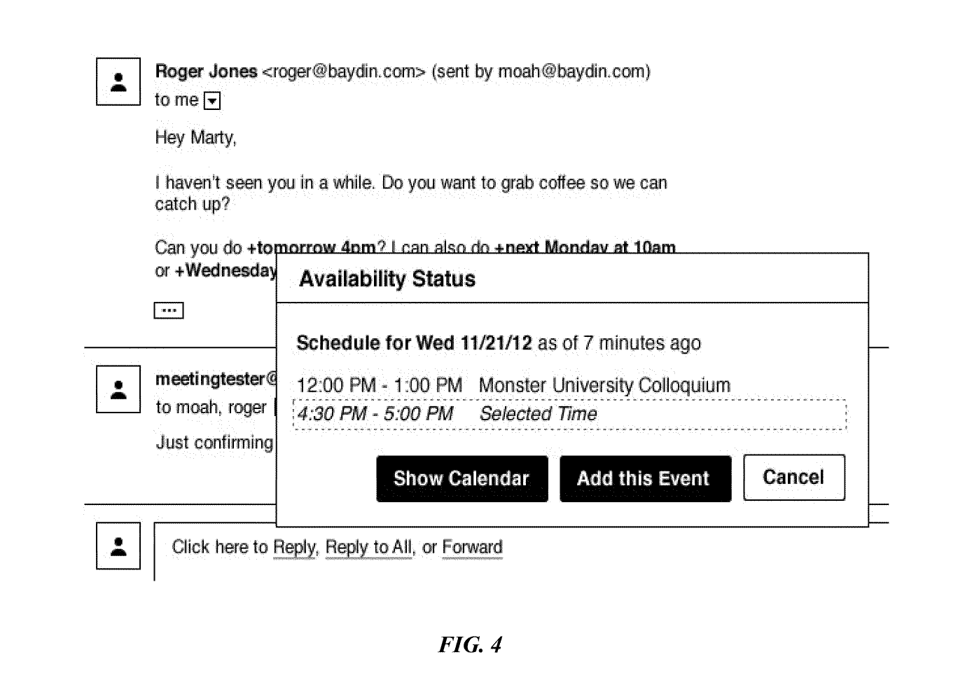

In reference now to FIG. 4, an embodiment of a method for incorporating calendar functionality into e-mail is depicted. The modified segment of natural language described with respect to FIG. 3 may be modified so as to display additional information related to calendar functionality upon interaction by a user. For example, and as shown in FIG. 4, a user may hover over the modified segment of natural language and a window may appear displaying additional information relating to calendar functionality. This additional information may provide the user with the ability to create a calendar entry at the time indicated in the relevant segment of natural language. For example, and as shown in FIG. 4, a user is shown his schedule for Wednesday November, 21 and the tentative calendar entry time (4:30-5:00 PM) is shown. The user may then click on the “Add This Event” button to add a calendar entry in his electronic calendar system or application directly from within the context of his or her electronic message interface. In some embodiments, such functionality may be made available upon “clicking” the relevant segment of natural language rather than hovering over it. In some embodiments, such functionality may be made available upon “clicking” or “hovering” above a character or symbol added before or after the segment of natural language (for example, the “+” sign that is shown in FIGS. 3 and 4.

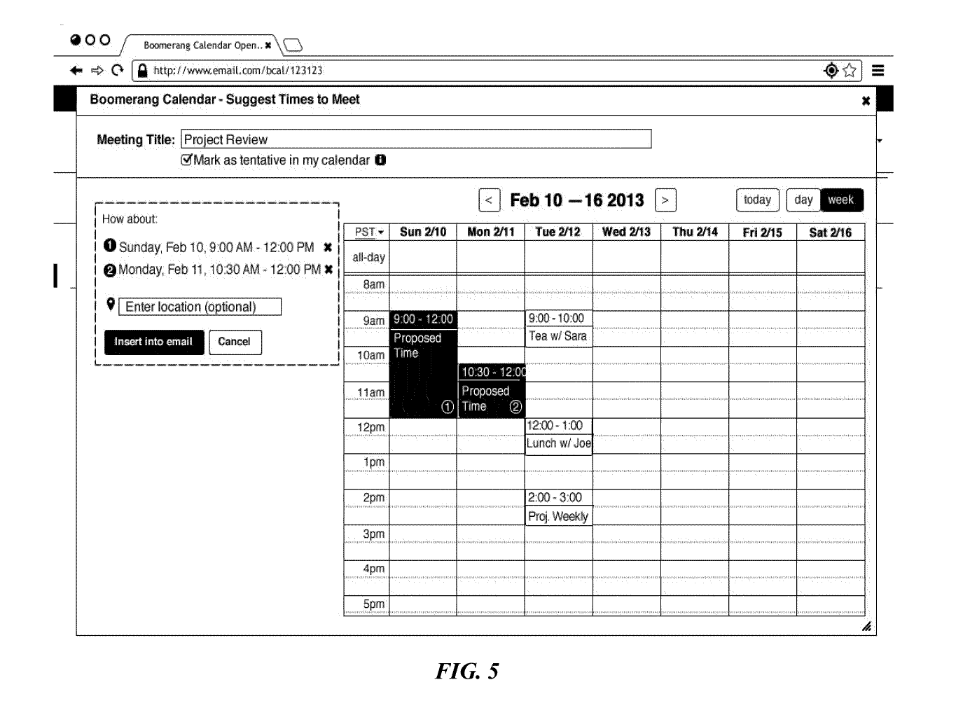

In reference now to FIG. 5, an embodiment of a method for incorporating calendar functionality into e-mail is depicted. In FIG. 5, a user may create one or more calendar entries that are identified as “tentative”. As shown in FIG. 5, a user may create a tentative calendar entry blocking off the period from 9:00 AM to 12:00 PM on Sunday and also a period from 10:30-12:00 PM on Monday. In some embodiments, these time entries may be suggested to a user, as demonstrated in the “How about” suggestion box on the left side of FIG. 5. In some embodiments, a user may accept one or more of the suggested periods for a tentative calendar entry, and may choose to insert these tentative times into an electronic message. For example, in FIG. 5, a user may simply click on the “Insert into email” button to add the tentative calendar entries into an e-mail for the purposes of proposing multiple times for a possible meeting or appointment to one or more prospective attendees.

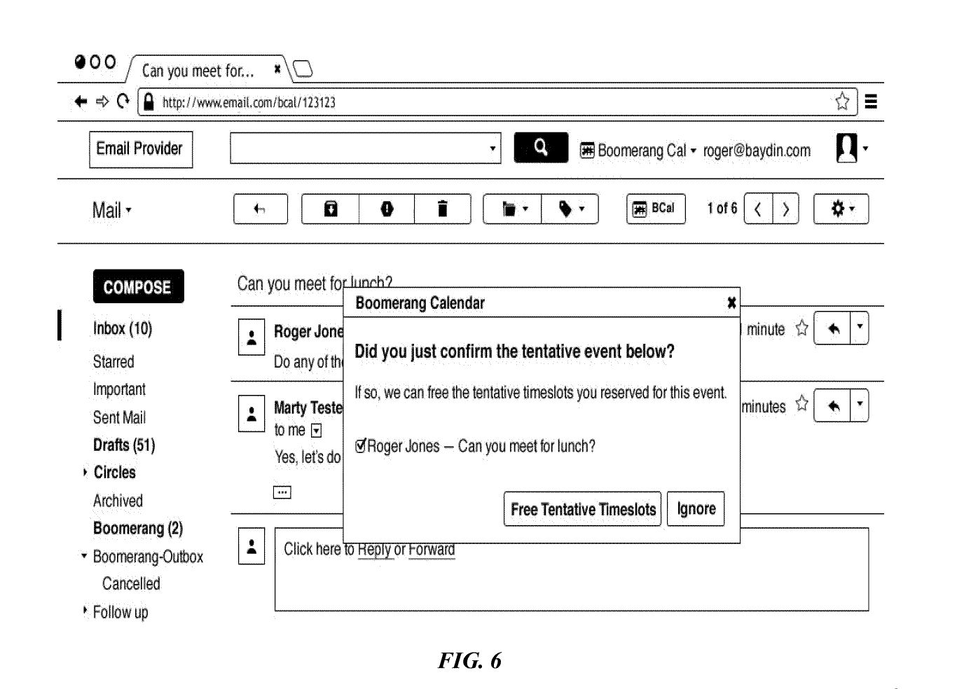

In reference now to FIG. 6, an embodiment of a method for incorporating calendar functionality into e-mail is depicted. In FIG. 6, a user may confirm a particular time slot for a calendar entry simply by responding to an e-mail received by another user proposing one or more time slots for a tentative calendar entry. For example, and in reference to FIG. 6, Roger Jones proposed a plurality of time slots for a tentative calendar entry to Marty Tester. Marty Tester responded “Yes, let's do Sunday . . . ” According to the invention of the present disclosure, a determination was made that the natural language in Marty Tester's Response was a confirmation to at least one of the time slots for a tentative calendar entry proposed by Roger Jones. Accordingly, and as shown in FIG. 6, the system prompts the user to confirm that a time slot for the tentative calendar entry has been confirmed. In some embodiments, a user may click on the “Free Tentative Timeslots button, which would create the calendar entry without a tentative identifier and would release the previous time slots identified as tentative for the tentative calendar entry. In some embodiments, the user may click the “Ignore” button as shown in FIG. 6 if they did not intend to confirm a calendar entry for one of the tentative time slots.

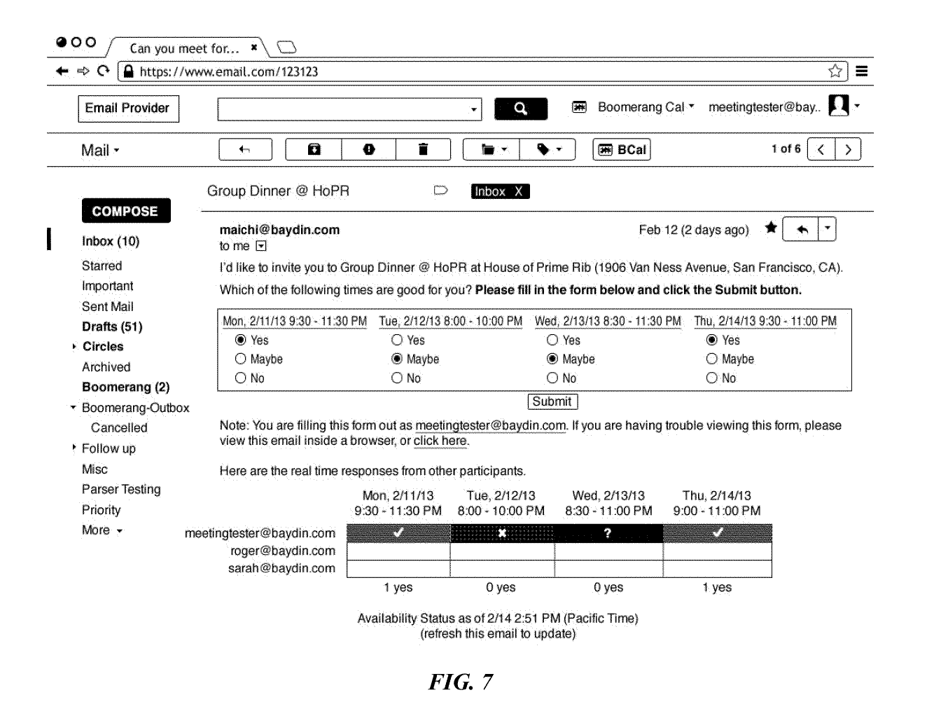

In reference now to FIG. 7, an embodiment of a method for incorporating calendar functionality into e-mail is depicted. As shown in FIG. 7, a user (maichi@baydin.com) may send an electronic message with a form (the table shown in FIG. 7 with dates and times in the first row and radio buttons indicating Yes/Maybe/No in each column) and an image (the second table with dates and times in the first rom, and each recipient's response to the form in the columns). As demonstrated in FIG. 7, recipient meetingtester@baydin.com has completed the form and has responses “Yes” (represented by a check mark) for the first proposed meeting time, “No” (represented by an “X” symbol) for the second proposed meeting time, “Maybe” (represented by a question mark) for the third proposed meeting time, and “Yes” (represented by a check mark) for the fourth proposed meeting time. As shown in FIG. 7, recipients roger@baydin.com and sarah@baydin.com have not yet responded to the form. The image also displays a total of “Yes” responses for each proposed meeting time, allowing the organizer and other recipients to easily see which proposed meeting time most recipients are able to attend. In some embodiments, the image shown in FIG. 7 may be shown via a reference embedded in the electronic message, such that the image may be changed without changing the content within the electronic message.

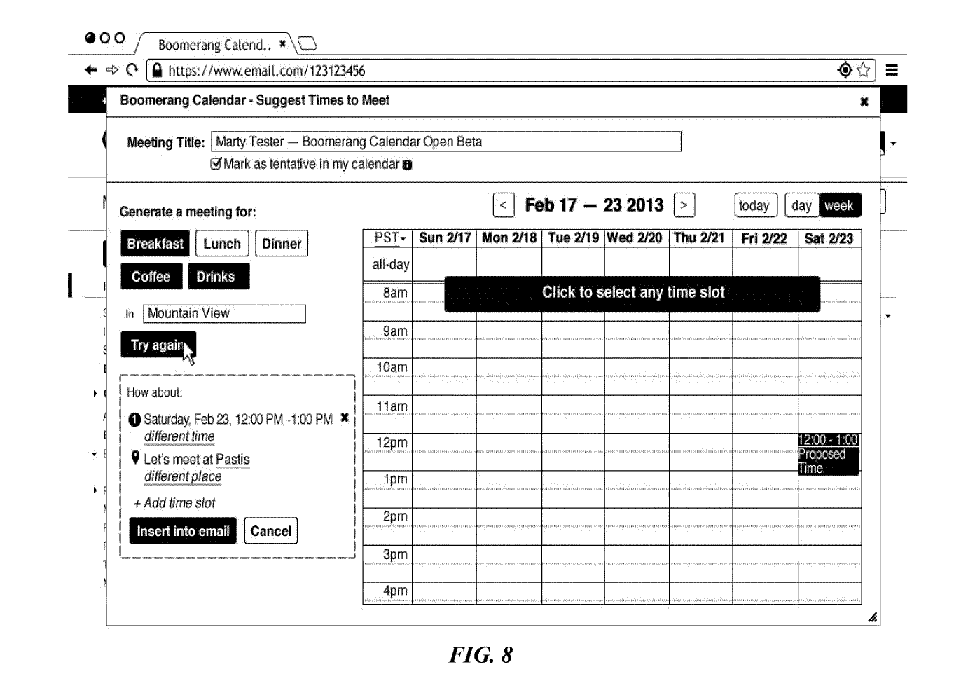

In reference now to FIG. 8, an embodiment of a method for incorporating calendar functionality into e-mail is depicted. As shown in FIG. 8, a user may create a calendar entry based, at least in part, on suggestion provided by the system. For example, and as shown in FIG. 8, a user may select from a variety of different classes of meetings, such as “Breakfast, Lunch, Dinner, Coffee or Drinks” The user is also asked to input a tentative geographic location for the meeting (in the present example, Mountain View). Based at least in part on the user's selection, and the user's preferred location, the user is offered a suggested time and place for the meeting. The suggested time may be based, at least in part, on the user's selection of a time slot, or, based on available time in the user's schedule. As shown in the example of FIG. 8, a time of Saturday, Feb 23 and 12:00 PM and a location of “Pastis” is suggested. In some embodiments, a user may choose what external data source is used for the suggestion of a meeting location. For example, in the example shown in FIG. 8, “Yelp” is being used as the data source. However, a user may be able to click on the “Powered by Yelp” log and choose a different provider. A user may also be able to click the “Try Again” button if they do not like the initial or subsequent suggestions. In some embodiments, rather than request that a user enter in a location for the meeting, geolocation data may be used and relied upon in suggesting a location for a meeting.

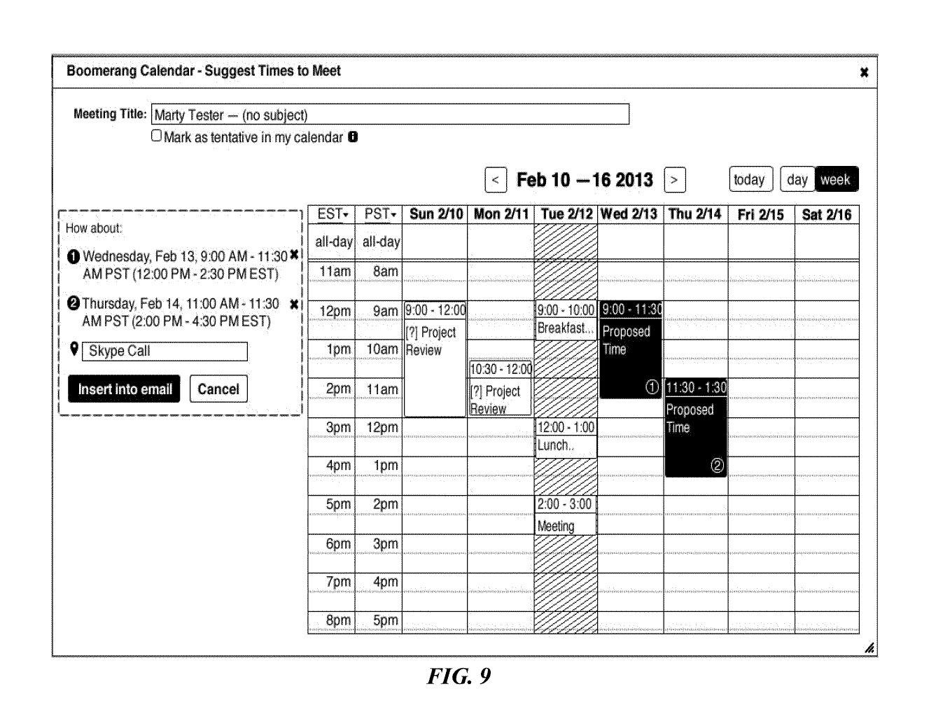

In reference now to FIG. 9, an embodiment of a method for incorporating calendar functionality into e-mail is depicted. As shown in FIG. 9 a suggested location may not be a physical location for a calendar entry, but, may rather be a description of the means for communication or a meeting format. For example, and as shown in FIG. 9, rather than a physical meeting a calendar entry may simply be for a telephone conference or video conference. In the example shown in FIG. 8, the suggested meeting format is a “Skype Call.” A suggested meeting format may be suggested by the system relying at least in part on past user preferences for a meeting format. For example, in some embodiments, the system may suggest a “Skype Call” for a calendar entry involving individuals who have had a “Skype Call” in the past.

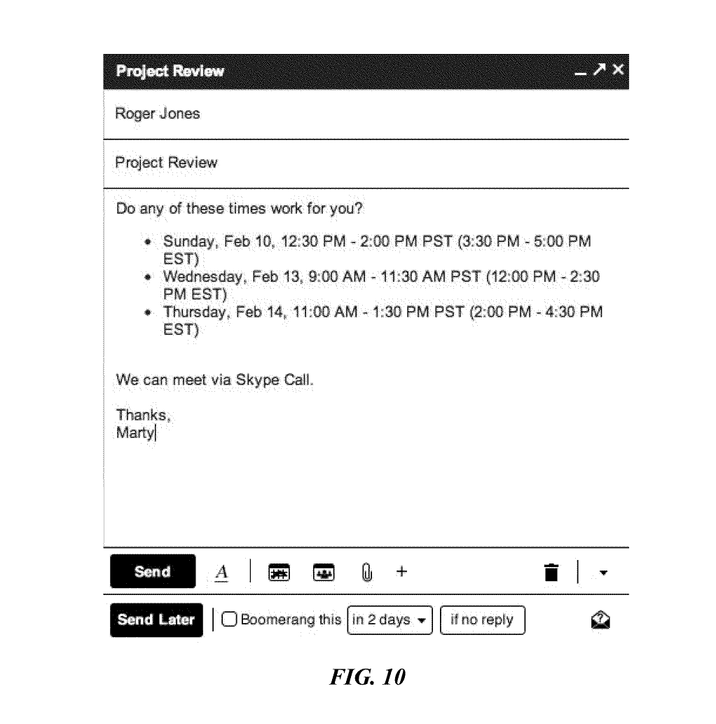

In reference now to FIG. 10, an embodiment of a method for incorporating calendar functionality into e-mail is depicted. As shown in FIG. 10 the system may generate a message to prospective recipients based at least in part on the suggestions for the calendar entry provided by the system. For example, if a user were to click on the “Insert into email” button shown in FIG. 9, they may be presented with the draft electronic message shown in FIG. 10. The suggested time, and the suggested meeting format (which may sometimes be referred to as the meeting “location” when the meeting is not a physical meeting) has been inserted into the electronic message as shown in FIG. 10. In some embodiments, the suggestion of a meeting format may rely, at least in part, on a determination that the prospective attendees are in different physical locations, or are in different time zones.

In reference now to FIG. 10, an exemplary embodiment of the present disclosure is depicted that facilitates the development of calendar entries for attendees across multiple time zones. As shown in FIG. 10, a user who desires to create a calendar entry involving attendees from across different time zones can easily see the differing time zones in the first two columns of the chart as shown (The Eastern Time Zone (EST) and the Pacific Time Zone (PST)).

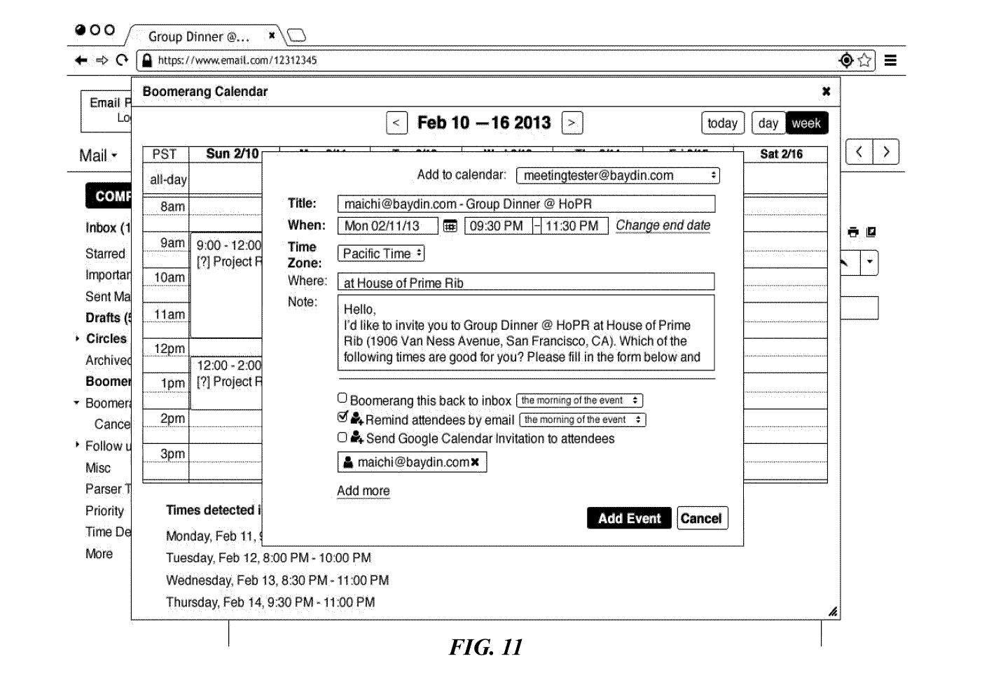

In reference now to FIG. 11, an exemplary embodiment of the present disclosure is depicted that provides for sending automatic electronic messages that serve as reminders for a calendar entry to all individuals associated with a particular calendar entry. As shown in FIG. 11, when a user is finalizing a calendar entry, they have the option of selecting the “Remind attendees by e-mail” option. By selecting this option, an electronic message will automatically be generated that will remind all individuals associated with the calendar entry that the meeting will occur. In some embodiments, a default time for the reminder message is provided to the user. In some embodiments, the default time may be determined based at least in part on the content of electronic messages associated with the calendar entry. In some embodiments, the default time may be determined based at least in part on the content of the calendar entry.

The features of the present disclosure which may specifically refer to embodiments of the present invention as applied to the management of electronic messages apply with equal force to more generalized embodiments of systems and methods for applying game mechanics to the completion of tasks. For example, systems and methods for deferring action on tasks are contemplated by the present disclosure in similar fashion as described in the context of deferring action on electronic messages. The various embodiments for determining scores in the context of managing electronic messages are also contemplated in the context of completing tasks. The various embodiments for timing a user's selection of an action to be applied to an electronic message are also contemplated in the context of the completion of tasks by users. Each and every feature and element of the present disclosure as described in the context of managing electronic messages is contemplated in the context of completing tasks.

It is understood by those skilled in the art that, unless expressly required, the steps of the various methods described herein need not be performed in any particular order.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program”, “software”, or “application” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method for incorporating calendar functionality into an electronic message comprising:
determining, by a computing device, that an electronic message received via a network contains a segment of natural language that relates to calendar functionality;
determining an association between said segment of natural language and structured data associated with a sender or a recipient of the electronic message in a structured data source;
modifying a representation of said segment of natural language to a user to reflect the association between said segment of natural language and structured data.

2. The method of claim 1, wherein the association of said structured data includes structured data stored by a calendar application.

3. The method of claim 1, wherein the structured data includes date and time information.

4. The method of claim 1, wherein the structured data includes calendar entry information.

5. The method of claim 1, wherein the structured data includes location information.

6. The method of claim 1, wherein the representation of said segment of natural language is modified by changing the color of the text.

7. The method of claim 1, wherein the representation of said segment of natural language is modified by changing the font of the text.

8. The method of claim 1, wherein the representation of said segment of natural language is modified by appending one or more characters before or after the segment of natural language.

9. The method of claim 1, wherein the representation of said segment of natural language is modified by appending one or more symbols before or after the segment of natural language.

10. The method of claim 1, wherein the representation of said segment of natural language is modified by appending an image before or after the segment of natural language.

11. The method of claim 1, wherein said calendar functionality is a calendar function selected from the group consisting of: creating a calendar entry; checking a schedule; determining a conflict in scheduling; assigning a location for a calendar entry; assigning a time for a calendar entry; inviting individuals to a calendar entry; inviting a group of individuals to a calendar entry; previewing a schedule with a potential calendar entry.

12. The method of claim 1, wherein determining that an electronic message contains a segment of natural language that relates to calendar functionality relies at least in part on other natural language in the electronic message.

13. The method of claim 1, wherein determining that an electronic message contains a segment of natural language that relates to calendar functionality relies at least in part on the subject of the electronic message.

14. The method of claim 1, wherein determining that an electronic message contains a segment of natural language that relates to calendar functionality relies at least in part on the content of prior electronic messages.

15. The method of claim 1, wherein the representation of said segment of natural language is modified by making the segment of natural language a link.

16. The method of claim 1, wherein the representation of said segment of natural language is modified such that additional information related to calendar functionality is displayed when the segment of natural language is clicked.

17. The method of claim 1, wherein the representation of said segment of natural language is modified such that additional information related to calendar functionality is displayed when a user hovers a mouse pointer above said segment.

18. The method of claim 15, wherein the link enables the display of additional information related to calendar functionality.

19. The method of claim 18, wherein the display of additional information related to calendar functionality allows a user to create a calendar entry.

20. The method of claim 16, wherein the display of additional information related to calendar functionality allows a user to create a calendar entry.

21. The method of claim 17, wherein the display of additional information related to calendar functionality allows a user to create a calendar entry.

22. The method of claim 18, wherein the display of additional information related to calendar functionality allows a user to modify a calendar entry.

23. The method of claim 16, wherein the display of additional information related to calendar functionality allows a user to modify a calendar entry.

24. The method of claim 17, wherein the display of additional information related to calendar functionality allows a user to modify a calendar entry.

25. The method of claim 1, wherein the segment of natural language is determined to be related to a particular time.

26. The method of claim 25, wherein modifying the representation of said segment of natural language to a user relies, at least in part, on the availability of said user for the particular time.

27. The method of claim 26, wherein modifying the representation of said segment of natural language to a user relies, at least in part, on the particular time.

28. The method of claim 27, wherein modifying the representation of said segment of natural language to a user involves changing the color of the segment of natural language to red if the user is unavailable for the particular time.

29. The method of claim 27, wherein modifying the representation of said segment of natural language to a user involves changing the color of the segment of natural language to green if the user is available for the particular time.

30. The method of claim 28, wherein modifying the representation of said segment of natural language to a user involves changing the color of the segment of natural language to yellow or orange if the user is tentatively available for the particular time.

31. The method of claim 1, wherein said structured data is data from a user's electronic calendar system.

32. The method of claim 1, wherein said structured data is data associated with the sender.

33. The method of claim 1, wherein said structured data is data associated with one or more recipients.

34. The method of claim 1, wherein said structured data is data from the sender's electronic calendar system.

35. The method of claim 1, wherein said structured data is data from at least one recipient's electronic calendar system

36. The method of claim 1, wherein said structured data reflects a calendar entry in an electronic calendar system.

37. The method of claim 1, wherein said structured data reflects that a user is not available during a particular time.

38. The method of claim 1, wherein said structured data reflects that a user is available during a particular time.

39. The method of claim 1, wherein modifying the representation of said segment of natural language to a user so relies, at least in part, on the structured data.

40. The method of claim 1, wherein modifying the representation of said segment of natural language to a user relies, at least in part, on structured data from an electronic calendar system.

41. An apparatus for incorporating calendar functionality into an electronic message, the apparatus comprising:
a memory to store processor-executable instructions; and
at least one processing unit communicatively coupled to the memory, wherein upon execution of the processor-executable instructions, the at least one processing unit:
determines that an electronic message contains a segment of natural language that relates to calendar functionality;
determines an association between said segment of natural language and structured data associated with a sender or a recipient of the electronic message in a structured data source;
modifies a representation of said segment of natural language to a user to reflect the association between said segment of natural language and structured data.

42. A computer-readable non-transitory storage medium encoded with computer-readable instructions that, as a result of being executed by a computing device, control the computing device to perform a method for managing electronic messages, the method comprising:
determining that an electronic message contains a segment of natural language that relates to calendar functionality;
determining an association between said segment of natural language and structured data associated with a sender or a recipient of the electronic message in a structured data source;
modifying a representation of said segment of natural language to a user to reflect the association between said segment of natural language and structured data.
